(19) United States
(12) Patent Application Publication
(10) Pub. No.: US 2009/0084754 A1
(43) Pub. Date: Apr. 2, 2009

(54) METHOD AND SYSTEM FOR MANUFACTURING MICROSTRUCTURE

(75) Inventors: Naoya HAYAMIZU, Kanagawa-ken (JP); Hiroshi Fujita, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/238,647

(22) Filed: Sep. 26, 2008

(30) Foreign Application Priority Data
Sep. 28, 2007 (JP) 2007-256188

(51) Int. Cl. B44C 1/22; C23F 1/08

(52) U.S. Cl. 216/13; 156/345.51

(57) ABSTRACT

A method for manufacturing a microstructure includes treating a surface of the microstructure having a wall body with a liquid, supplying a material activating the surface of the liquid to the surface of the microstructure, and drying the surface of the microstructure.

### CROSS-REFERENCE TO RELATED APPLICATIONS

This application is based upon and claims the benefit of priority from the prior Japanese Patent Application No. 2007-256188, filed on Sep. 28, 2007; the entire contents of which are incorporated herein by reference.

### BACKGROUND OF THE INVENTION

1. Field of the Invention

This invention relates to a method for manufacturing a microstructure and a system for manufacturing a microstructure.

2. Background Art

In the field of semiconductor devices and MEMS (microelectromechanical systems), lithography is used to manufacture a microstructure having fine wall bodies at the surface. Cleaning is performed to remove organic and inorganic contamination occurring in the manufacturing process to keep the surface of the microstructure clean.

In such cleaning, pure water or other cleaning liquid is supplied to the surface of the microstructure to remove attached organic matter. To enhance the drying effect and reduce residual water droplets and water marks, alcohol such as isopropyl alcohol is supplied to the cleaned surface during drying (see, e.g., JP-A 2000-003897(Kokai)).

However, in such techniques as disclosed in JP-A 2000-003897(Kokai), the effect of surface tension of the cleaning liquid remaining between fine wall bodies formed at the surface of the microstructure is not considered. This surface tension may deform or destroy the fine wall bodies.

### SUMMARY OF THE INVENTION

According to an aspect of the invention, there is provided a method for manufacturing a microstructure, including: treating a surface of the microstructure having a wall body with a liquid, supplying a material activating the surface of the liquid to the surface of the microstructure, and drying the surface of the microstructure.

According to another aspect of the invention, there is provided a method for manufacturing a microstructure, including: applying hydrophilization treatment to a surface of the microstructure having a wall body, treating the surface with a liquid, and drying the surface.

According to another aspect of the invention, there is provided a system for manufacturing a microstructure, including: a treating device configured to treat a surface of the microstructure having a wall body with a liquid; an activator supplying device configured to supply a material activating the surface of the liquid to the surface of the microstructure; and a drying device configured to dry the surface of the microstructure.

### BRIEF DESCRIPTION OF THE DRAWINGS

FIG. 1 is a flow chart for illustrating a method for manufacturing a microstructure according to a first embodiment of the invention;

FIGS. 2A to 2E are schematic cross-sectional views for illustrating the effect of surface tension of the liquid remaining between wall bodies;

FIG. 3 is a flow chart for illustrating a method for manufacturing a microstructure according to a second embodiment of the invention;

FIG. 4 is a flow chart for illustrating a method for manufacturing a microstructure according to a third embodiment of the invention;

FIG. 5 is a flow chart for illustrating a method for manufacturing a microstructure according to a fourth embodiment of the invention;

FIG. 6 is a schematic view for illustrating a system for manufacturing a microstructure according to a fifth embodiment of the invention; and

FIGS. 7A and 7B are schematic views for illustrating a system for manufacturing a microstructure according to a sixth embodiment of the invention.

### DETAILED DESCRIPTION OF THE INVENTION

Embodiments of the invention will now be illustrated with reference to the drawings.

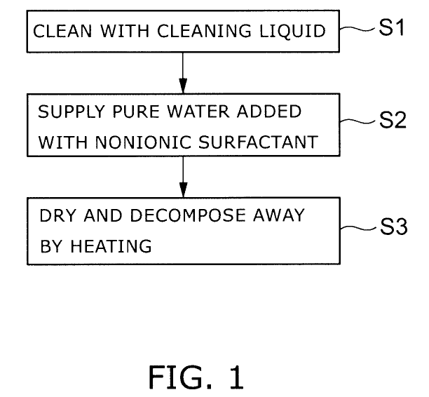

FIG. 1 is a flow chart for illustrating a method for manufacturing a microstructure according to a first embodiment of the invention.

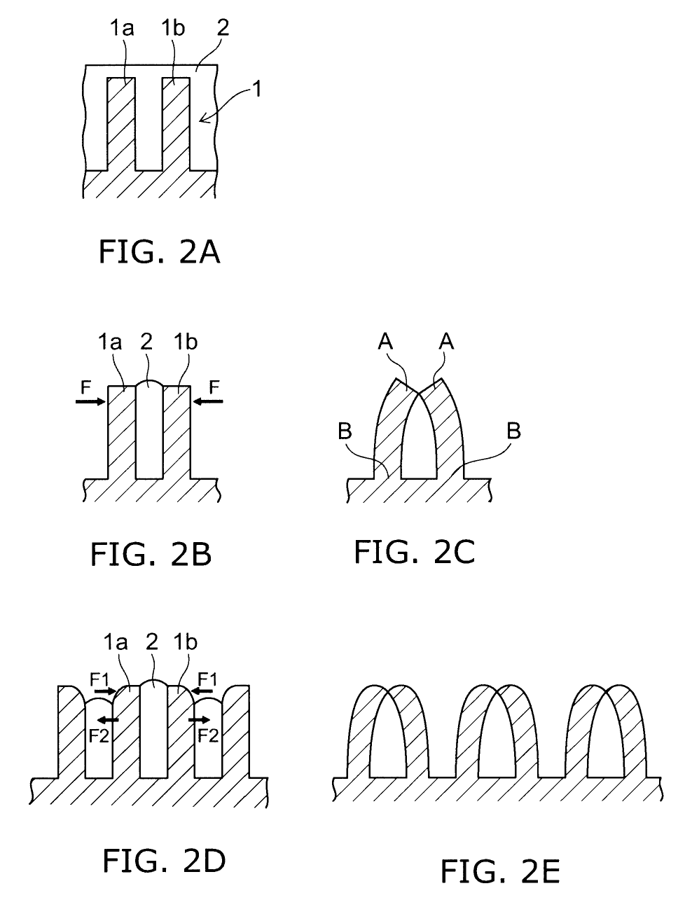

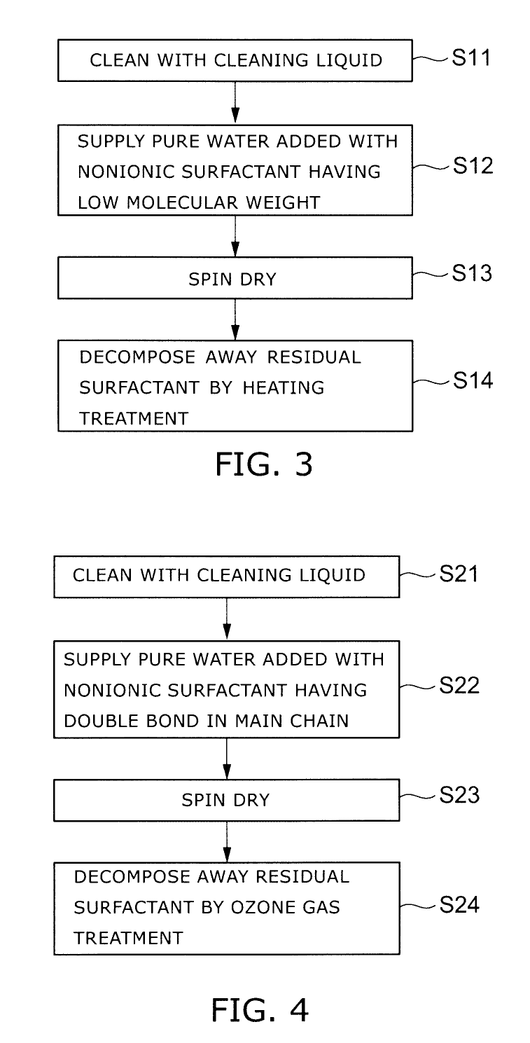

FIGS. 2A to 2E are schematic cross-sectional views for illustrating the effect of surface tension of the liquid remaining between wall bodies. In FIG. 1, as an example, the case of performing cleaning with a cleaning liquid is illustrated. However, the invention is not limited thereto, but applicable to various other processes using a liquid including etching, deposition, and surface treatment. This also applies to the examples described below with reference to FIG. 3 and the subsequent figures.

First, the effect of surface tension of the liquid remaining between wall bodies is described.

As shown in FIG. 2A, when a microstructure 1 is treated with a liquid such as a cleaning liquid, the surface of the microstructure 1 is covered with the liquid 2, and the gap between wall bodies 1a, 1b (in the pattern) formed at the surface is also filled with the (cleaning) liquid 2. Here, the wall body 1a, 1b may be shaped like a wall, or may be shaped like a cylindrical or prismatic rod.

Next, as shown in FIG. 2B, in drying after the treatment, the liquid 2 is removed from the surface of the microstructure 1, and the top surface of the wall bodies 1a, 1b are exposed to the atmosphere. Then, surface tension of the liquid 2 remaining between the wall bodies 1a, 1b causes an acting force F laterally pushing the wall bodies 1a, 1b to work thereon.

Here, if the wall bodies 1a, 1b have sufficiently high strength, the effect of the acting force F is small. However, depending on the material, degree of downscaling (degree of integration), and aspect ratio of the microstructure 1, it is necessary to avoid the acting force F. For example, in the field of semiconductor devices and MEMS, the effect of the acting force F is not negligible for a design rule of 30 nm (nanometers) or less.

In such cases, as shown in FIG. 2C, the wall bodies 1a, 1b may be deformed into a curved configuration. If the wall bodies 1a, 1b are deformed, contact may occur at the tip A, or fracture or crack may occur at the base B.

Furthermore, if the shape of the wall body 1a, 1b is not symmetric, the acting force F caused by surface tension is nonuniform, and the deformation of the wall body 1a, 1b is more likely to occur. For example, in the case shown in FIG. 2D, the amount of liquid 2 remaining between the wall bodies 1a, 1b varies, and the magnitude of the acting forces F1, F2 caused by surface tension and the position of action vary. More specifically, as shown in FIG. 2D, the acting force F1 is larger than the acting force F2, and the position of action of the acting force F1 is nearer to the tip. Thus, the bending moment caused by the acting force F1 is larger, and hence the deformation in the direction as shown in FIG. 2E is likely to occur.

The microstructure 1 illustrated in FIGS. 2A to 2E is a structure made of a single material (e.g., silicon or amorphous silicon). However, the same applies to a microstructure 1 of a laminated body made of metals, silicon, and oxides.

To determine the effect of this surface tension, a wafer with a 30-nm design rule pattern formed on the surface was spin-cleaned with pure water (rotation speed: approximately 500 rpm, cleaning time: approximately 60 seconds) and spin-dried (rotation speed: approximately 2500 rpm, drying time: approximately 60 seconds). The patterns before and after cleaning were inspected by comparison using a pattern inspection system manufactured by KLA Instruments. As a result, deformation was observed at 12 locations in the pattern.

As a result of study, the inventor has found that the deformation of the wall body can be prevented by supplying a material activating the liquid surface to reduce the surface tension of the liquid.

Materials activating the liquid surface can illustratively be surfactants, polar solvents such as alcohols, furans, and ketones, or fine particles of silica, alumina, and titanium oxide measuring approximately several nm to 1 μm.

Surfactants illustratively include cationic surfactants, anionic surfactants, nonionic surfactants, and fluorochemical surfactants. For example, anionic surfactants illustratively include alkylbenzenesulfonates, dialkylsulfosuccinates, and alkylsulfate ester salts having a carboxy group, sulfo group, or sulfate group and dissociated in water into anions. Cationic surfactants illustratively include alkylamine salts, quaternary ammonium salts, and perfluoroalkylamine compounds, dissociated in water into cations. Nonionic surfactants illustratively include alkylbetaines and imidazolium betaines. Fluorochemical surfactants illustratively include perfluoroalkylbetaines (e.g., trade name SURFLON S-131, manufactured by Asahi Glass Co., Ltd.) and perfluoroalkylcarbonic acids (e.g., trade name SURFLON S-113, 121, manufactured by Asahi Glass Co., Ltd.).

The type of surfactants is not particularly limited. However, nonionic surfactants are preferable because they are less susceptible to electrolytes and can also be used in combination with additives for other purposes.

If the surfactant can be volatilized away in drying after cleaning, the effect of residual surfactant can be prevented. To this end, the surfactant preferably has a low molecular weight.

In the case where residual surfactant remains, preferably, it is easily decomposed away by heating or ozonization. To this end, preferably, the surfactant has a low molecular weight, or has a double bond in the main chain and is easily decomposed into low molecular weight portions.

Next, returning to FIG. 1, a method for manufacturing a microstructure according to the first embodiment of the invention is illustrated.

For convenience of description, it is assumed that the microstructure 1 is a wafer with a 30-nm design rule pattern formed on the surface.

First, the patterned wafer surface (the surface of the microstructure having wall bodies) is cleaned with a liquid (e.g., pure water) (step S1).

Cleaning can be performed by spin cleaning, with a rotation speed of approximately 500 rpm and a cleaning time of approximately 60 seconds.

Next, a material activating the liquid surface is supplied to the wafer surface. In this embodiment, pure water added with a nonionic surfactant is supplied to the wafer surface (step S2).

The supply can be performed on the surface of the rotated wafer like spin cleaning, with a rotation speed of approximately 500 rpm and a supply time of approximately 10 seconds. In this case, the added amount of nonionic surfactant is preferably 0.05 weight % or more and 1 weight % or less. With less than 0.05 weight %, the effect of reducing surface tension is excessively decreased, whereas with more than 1 weight %, removal of residual surfactant needs to be considered. In the case of a microstructure 1 allowing high-temperature removal treatment or in the case where the surfactant is removed together with the underlying material in the subsequent etching or other process, there is no need to consider the effect of residual surfactant. Hence, in such cases, the added amount of surfactant can exceed 1 weight %.

Next, by heating with rotation, the wafer is dried, and the surfactant is decomposed away (step S3).

Here, the heating temperature can be approximately 150° C., the heating time can be approximately 60 seconds, and the rotation speed can be approximately 500 rpm.

The wafer surface after this process of drying and decomposing away the surfactant was analyzed by X-ray photoelectron spectroscopy (XPS). Carbon was 1% or less, and no residual surfactant was observed. Furthermore, the wafer surface after drying and decomposing away the surfactant was inspected using the pattern inspection system manufactured by KLA Instruments. The pattern configuration was left unchanged from that before cleaning, and no pattern deformation was observed.

FIG. 3 is a flow chart for illustrating a method for manufacturing a microstructure according to a second embodiment of the invention.

For convenience of description, it is assumed that the microstructure 1 is a wafer with a 30-nm design rule pattern formed on the surface.

First, the patterned wafer surface (the surface of the microstructure having wall bodies) is treated with a liquid. Specifically, cleaning is performed with a cleaning liquid (e.g., pure water) (step S11).

Cleaning can be performed by spin cleaning, with a rotation speed of approximately 500 rpm and a cleaning time of approximately 60 seconds.

Next, a material activating the liquid surface is supplied to the wafer surface. In this embodiment, pure water added with a nonionic surfactant having a low molecular weight is supplied to the wafer surface (step S12).

The supply can be performed on the surface of the rotated wafer like spin cleaning, with a rotation speed of approximately 500 rpm and a supply time of approximately 10 seconds.

In this embodiment, a surfactant having a low molecular weight is used. In this case, preferably, the molecular weight is approximately 200 or less, because it facilitates removal by volatilization and removal by decomposition.

The added amount of nonionic surfactant is preferably 0.05 weight % or more and 1 weight % or less. With less than 0.05 weight %, the effect of reducing surface tension is excessively decreased, whereas with more than 1 weight %, removal of residual surfactant needs to be considered. In the case of a microstructure 1 allowing high-temperature removal treatment or in the case where the surfactant is removed together with the underlying material in the subsequent etching or other process, there is no need to consider the effect of residual surfactant. Hence, in such cases, the added amount of surfactant can exceed 1 weight %.

Next, spin drying is performed (step S13).

Here, the rotation speed can be approximately 2500 rpm, and the drying time can be approximately 60 seconds.

The wafer surface after this drying step was inspected using the pattern inspection system manufactured by KLA Instruments. The pattern configuration was left unchanged from that before cleaning, and no pattern deformation was observed.

Next, the residual surfactant is decomposed away by heating treatment with rotation (step S14).

Here, the heating treatment temperature can be approximately 150° C., the heating treatment time can be approximately 60 seconds, and the rotation speed can be approximately 500 rpm.

The wafer surface after this heating treatment was analyzed by X-ray photoelectron spectroscopy (XPS). Carbon was 1% or less, and no residual surfactant was observed.

FIG. 4 is a flow chart for illustrating a method for manufacturing a microstructure according to a third embodiment of the invention.

For convenience of description, it is assumed that the microstructure 1 is a wafer with a 30-nm design rule pattern formed on the surface.

First, the patterned wafer surface (the surface of the microstructure having wall bodies) is treated with a liquid. Specifically, cleaning is performed with a cleaning liquid (e.g., pure water) (step S21).

Cleaning can be performed by spin cleaning, with a rotation speed of approximately 500 rpm and a cleaning time of approximately 60 seconds.

Next, a material activating the liquid surface is supplied to the wafer surface. In this embodiment, pure water added with a nonionic surfactant having a double bond in the main chain is supplied to the wafer surface (step S22).

The supply can be performed on the surface of the rotated wafer like spin cleaning, with a rotation speed of approximately 500 rpm and a supply time of approximately 10 seconds.

In this embodiment, a surfactant having a double bond in the main chain is used. Such surfactants illustratively include nonionic surfactants represented by the following general formula. Here, the number and position of double bonds are not particularly limited, but the number is preferably such that the surfactant can be decomposed into molecular weights that facilitate removal by volatilization and removal by decomposition. The general formula is given by:

RₚO_{q}(EO)ᵣH

where R is an alkenyl group having 8 to 20 carbon atoms, EO denotes ethylene oxide, p, q, and r denote average added mole numbers, in which p is 1 to 13, q is 1 to 4, and r is 2 to 26.

Here, the surfactant represented by the following chemical formula is preferable:

CH₃—(CH₂)₃—(CH═CH)—(CH₂)₄—O(EO)₁₀H

The added amount of nonionic surfactant is preferably 0.05 weight % or more and 1 weight % or less. With less than 0.05 weight %, the effect of reducing surface tension is excessively decreased, whereas with more than 1 weight %, removal of residual surfactant needs to be considered. In the case of a microstructure 1 allowing high-temperature removal treatment or in the case where the surfactant is removed together with the underlying material in the subsequent etching or other process, there is no need to consider the effect of residual surfactant. Hence, in such cases, the added amount of surfactant can exceed 1 weight %.

Next, spin drying is performed (step S23).

Here, the rotation speed can be approximately 2500 rpm, and the drying time can be approximately 60 seconds.

The wafer surface after this drying step was inspected using the pattern inspection system manufactured by KLA Instruments. The pattern configuration was left unchanged from that before cleaning, and no pattern deformation was observed.

Next, the residual surfactant is decomposed away using ozone gas (step S24).

Here, the temperature of ozone gas can be approximately 40° C., and the treatment time can be approximately 30 seconds.

The wafer surface after this ozone gas treatment was analyzed by X-ray photoelectron spectroscopy (XPS). Carbon was 1% or less, and no residual surfactant was observed.

In the embodiments illustrated above, pure water added with a surfactant (material activating the liquid surface) is supplied. However, it is also possible to spray a solution of a surfactant (material activating the liquid surface) for direct supply.

Furthermore, the liquid added with a surfactant (material activating the liquid surface) can be used in the first cleaning step. However, in view of reducing the amount of surfactant (material activating the liquid surface), it is preferable to perform cleaning separately from reduction of surface tension (supply of the surfactant (material activating the liquid surface)) during drying.

Furthermore, the method of decomposing away the residual surfactant (material activating the liquid surface) is not limited to the illustrated method. For example, it is possible to suitably select treatment methods capable of decomposing away the surfactant (material activating the liquid surface), such as plasma treatment and UV (ultraviolet) irradiation.

Furthermore, it is preferable to supply the material activating the liquid surface while the liquid remains on the surface of the microstructure 1. The timing of supply can be suitably changed depending on the strength of the wall body, such as the material, degree of downscaling (degree of integration), and aspect ratio of the microstructure 1.

As a result of further study, the inventor has found that the deformation of the wall body can be prevented by applying hydrophilization treatment to the surface of the microstructure 1 to reduce the surface tension of the liquid. In this case, the cleaning effect can be also enhanced because wettability is increased and the liquid more easily infiltrates between the wall bodies.

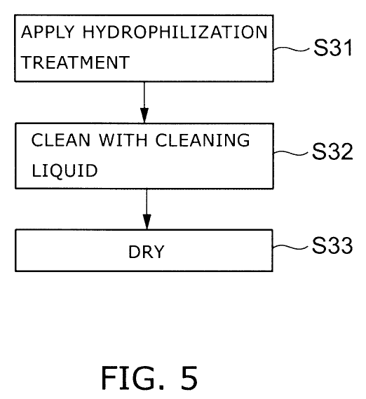

FIG. 5 is a flow chart for illustrating a method for manufacturing a microstructure according to a fourth embodiment of the invention.

First, hydrophilization treatment is applied to the surface of the microstructure having wall bodies (step S31).

The hydrophilization treatment can be suitably selected depending on the material of the microstructure 1. For example, in the case where the microstructure 1 is made of silicon (such as a wafer), treatments capable of forming silicon oxide on the surface can be suitably selected. Treatments capable of forming silicon oxide illustratively include thermal oxidation of silicon and oxygen plasma treatment. Other hydrophilization treatments illustratively include surface treatment by UV (ultraviolet) or EB (electron beam) irradiation, film formation of hydrophilic material by normal pressure CVD, reduced pressure CVD, or plasma CVD, and surface treatment with chemicals. It is noted that the invention is not limited to these treatments, but treatments capable of hydrophilizing the surface of the microstructure 1 can be suitably selected.

Next, the microstructure 1 is treated with a liquid. Specifically, cleaning is performed thereon (step S32).

Cleaning can illustratively be spin cleaning with pure water. However, the cleaning method is not limited thereto, but can be suitably changed. Furthermore, the liquid is not limited to pure water, but other liquids can be suitably selected, including water added with additives.

Next, the microstructure 1 is dried (step S33).

Drying can illustratively be spin drying or heat drying. However, the drying method is not limited thereto, but can be suitably changed.

After cleaning, it is also possible to supply the above-described material activating the liquid surface (e.g., surfactant).

Next, a system for manufacturing a microstructure according to an embodiment of the invention is described.

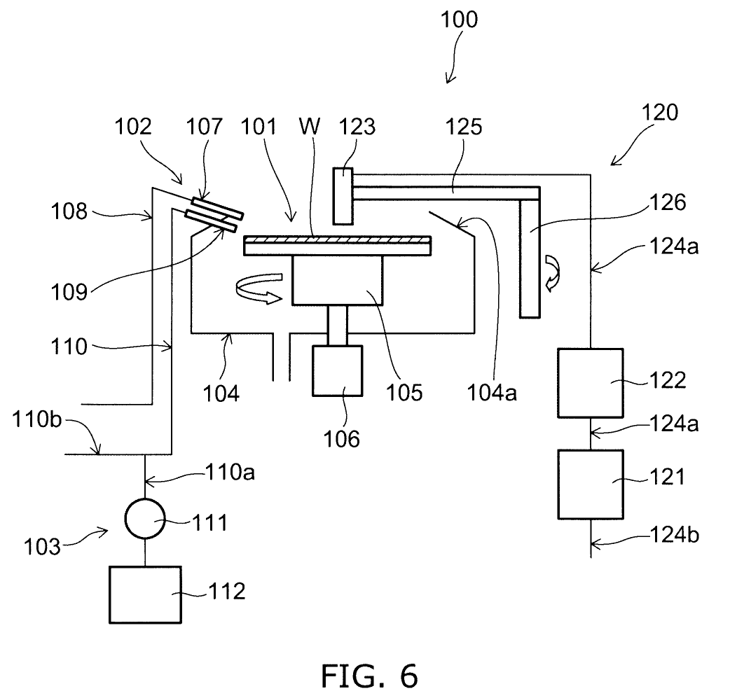

FIG. 6 is a schematic view for illustrating a system for manufacturing a microstructure according to a fifth embodiment of the invention.

For convenience of description, it is assumed that the microstructure 1 is a wafer W.

As shown in FIG. 6, the microstructure manufacturing system 100 comprises a holding means 101 for holding a wafer W (microstructure 1), a cleaning means 102 for cleaning the surface of the patterned wafer W (the microstructure having wall bodies) with a liquid, and an activator supplying means 103 for supplying a material activating the liquid surface (e.g., surfactant) to the surface of the patterned wafer W (the microstructure having wall bodies).

The manufacturing system 100 further comprises a removing means 120 for decomposing away the material activating the liquid surface (e.g., surfactant) remaining on the surface of the patterned wafer W (the microstructure having wall bodies). As described later, by superheated steam from the removing means 120, the residual material activating the liquid surface (e.g., surfactant) can be decomposed away, and the surface of the wafer W (microstructure 1) can also be dried. That is, in this embodiment, the removing means 120 includes the function of drying means for drying the surface of the wafer W (microstructure 1).

Furthermore, a chamber 104 is provided to surround the holding means 101.

The holding means 101 has a chuck 105 capable of holding the wafer W (microstructure 1) and a driving means 106 (e.g., motor) for rotating the chuck 105. The chuck 105 horizontally holds the wafer W (microstructure 1) one by one and can be rotated by the driving means 106.

The cleaning means 102 has a nozzle 107 provided above the chuck 105 and discharging a liquid toward the surface of the wafer W (microstructure 1) and a liquid supplying means, not shown, connected to the nozzle 107 through a piping 108. The liquid supplied by the liquid supplying means, not shown, can illustratively be pure water. However, the liquid is not limited to pure water, but other liquids can be suitably selected, including water added with additives.

The activator supplying means 103 has a nozzle 109 provided above the chuck 105 and discharging a liquid added with a material activating the liquid surface (e.g., surfactant) (the liquid is hereinafter referred to as the liquid surfactant) toward the surface of the wafer W (microstructure 1). A piping 110, connected to the nozzle 109, is bifurcated into two pipings 110a and 110b. A supplying means 111 for supplying the material activating the liquid surface (e.g., surfactant) is connected to one piping 110a, and a pure water supplying means, not shown, is connected to the other piping 110b. The supplying means 111 is also connected to a container 112 for containing the material activating the liquid surface (e.g., surfactant) through a piping 110c. In the case where the material activating the liquid surface (e.g., surfactant) is a liquid or other fluid, the supplying means 111 can be a pump. The material activating the liquid surface (e.g., surfactant) contained in the container 112 can illustratively be a nonionic surfactant. However, the material is not limited thereto, but can be suitably changed.

The removing means 120 primarily has an evaporator 121 for generating saturated steam, a superheater 122 for generating superheated steam, and a nozzle 123 provided above the chuck 105 and expelling superheated steam toward the surface of the wafer W (microstructure 1). The nozzle 123 is held by an arm 125, which is rotatable about a rotary shaft 126.

The evaporator 121, the superheater 122, and the nozzle 123 are connected by a piping 124a, and the evaporator 121 is connected to a pure water supplying means, not shown, by a piping 124b. Thus, pure water supplied from the pure water supplying means, not shown, can be heated by the evaporator 121 into saturated steam. The saturated steam can be superheated by the superheater 122 into dry steam with no mist (superheated steam), and the superheated steam can be expelled from the nozzle 123 toward the wafer W (microstructure 1). Thus, the superheated steam can dry the surface of the wafer W (microstructure 1) and thermally decompose away the residual surfactant.

The chamber 104 can catch and drain the liquid and liquid surfactant spattered by the rotation of the wafer W (microstructure 1). An inclined portion 104a for catching the spattered liquid and liquid surfactant and guiding it into the chamber 104 is provided at the top of the chamber 104. A drain pipe 104b for draining out the liquid and liquid surfactant collected in the chamber 104 is connected to the bottom of the chamber 104.

Next, the operation of the microstructure manufacturing system 100 is described.

A wafer W (microstructure 1) is transported into the chamber 104 by a transporting means, not shown, and mounted and held on the chuck 105. The chuck 105 can be rotated by the driving means 106 at a speed of several hundred to several thousand revolutions per minute. Hence, the wafer W (microstructure 1) held by the chuck 105 can also be rotated with the chuck 105.

A liquid is supplied from the nozzle 107 disposed above the wafer W (microstructure 1) to the surface of the rotating wafer W (microstructure 1). After a prescribed amount of liquid required for cleaning is supplied to the surface of the rotating wafer W (microstructure 1), the supply of the liquid is stopped.

Then, a liquid surfactant is supplied to the surface of the rotating wafer W (microstructure 1). Here, the supply of the liquid surfactant is performed before the liquid is removed from the surface of the wafer W (microstructure 1) by rotation, that is, while the liquid remains on the surface of the wafer W (microstructure 1). Here, the supply of the liquid surfactant can be started immediately before the supply of the liquid is stopped. After a prescribed amount of liquid surfactant is supplied to the surface of the rotating wafer W (microstructure 1), the supply of the liquid surfactant is stopped.

Then, superheated steam is supplied from the nozzle 123 disposed above the wafer W (microstructure 1) to the surface of the rotating wafer W (microstructure 1). After a prescribed amount of superheated steam is supplied to the surface of the rotating wafer W (microstructure 1), the supply of superheated steam is stopped. Here, the wafer W (microstructure 1) can be rotated at high speed to spin off water droplets on the surface, thereby also reducing the drying time.

Upon completion of drying of the wafer W (microstructure 1) as well as heat decomposition and removal of the residual surfactant, the rotation of the chuck 105 is stopped, and the wafer W (microstructure 1) is transported out by the transporting means, not shown. Then, by repeating the above procedure if necessary, the manufacturing of the wafer W (microstructure 1) is performed.

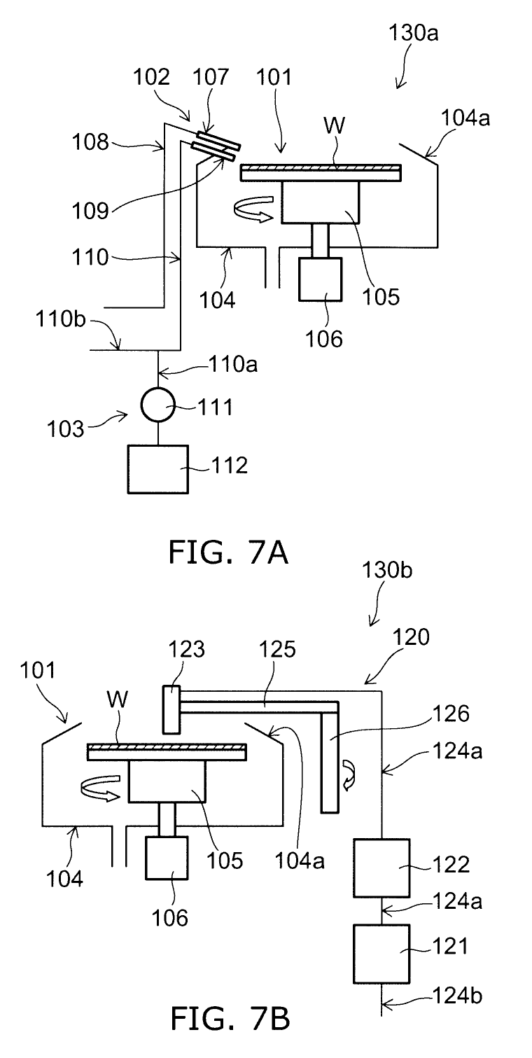

FIGS. 7A and 7B are schematic views for illustrating a system for manufacturing a microstructure according to a sixth embodiment of the invention. The same elements as those illustrated in FIG. 6 are labeled with like reference numerals, and the description thereof is omitted.

The microstructure manufacturing system illustrated in FIGS. 7A and 7B comprises a first manufacturing system 130a shown in FIG. 7A and a second manufacturing system 130b shown in FIG. 7B. Furthermore, a transporting means, not shown, for passing a wafer W (microstructure 1) between the first manufacturing system 130a and the second manufacturing system 130b is provided.

The first manufacturing system 130a primarily has a holding means 101, a cleaning means 102, and an activator supplying means 103, and primarily performs cleaning of the wafer W (microstructure 1) and supply of a material activating the liquid surface (e.g., surfactant).

The second manufacturing system 130b primarily has a holding means 101 and a removing means 120, and primarily performs drying of the wafer W (microstructure 1) and removal by heat decomposition of the residual material activating the liquid surface (e.g., surfactant).

The components of the microstructure manufacturing system 100 illustrated in FIG. 6 are similar to the components of the first manufacturing system 130a and the second manufacturing system 130b. Thus, the description of the operation thereof is also omitted.

In this embodiment, the microstructure manufacturing system 100 illustrated in FIG. 6 is divided into the first manufacturing system 130a and the second manufacturing system 130b. Thus, by dividing the functions, the number of manufacturing systems responsible for time-consuming processes is increased to reduce dead time and improve productivity.

In FIGS. 6, and 7A and 7B, the removing means 120 using superheated steam is illustrated, but the removing means 120 is not limited thereto. For example, it is possible to suitably select treatment methods capable of decomposing away the material activating the liquid surface (e.g., surfactant), such as treatment using ozone gas, plasma treatment, UV (ultraviolet) irradiation treatment, and heating treatment by heated air.

The microstructure manufacturing system illustrated above is based on single-wafer processing. However, alternatively, it can be based on batch processing. For example, in a processing bath, a plurality of microstructures can collectively undergo cleaning, supply of the material activating the liquid surface (e.g., surfactant), drying, and removal of the residual material activating the liquid surface (e.g., surfactant).

Furthermore, the microstructure manufacturing system can include an apparatus for forming a wall body at the surface of a microstructure. For example, the microstructure manufacturing system can be configured so that apparatuses used in lithography processes such as resist coating, exposure, development, etching, and resist removal are incorporated in the manufacturing line. Here, known techniques are applicable to the apparatuses used in lithography processes, and hence the description thereof is omitted.

For convenience of description, it is assumed that the microstructure is a wafer. However, the invention is not limited thereto. For example, the invention can be adapted to liquid crystal display devices, phase shift masks, micromachines in the MEMS field, and precision optical components.

The embodiments of the invention have been illustrated. However, the invention is not limited to the above description.

The above embodiments can be suitably modified by those skilled in the art, and such modifications are also encompassed within the scope of the invention as long as they fall within the spirit of the invention.

For example, the shape, dimension, material, and layout of the microstructure and the microstructure manufacturing system are not limited to those illustrated, but can be suitably modified.

The elements included in the above embodiments can be combined as long as feasible, and such combinations are also encompassed within the scope of the invention as long as they fall within the spirit of the invention.

1. A method for manufacturing a microstructure, comprising: treating a surface of the microstructure having a wall body with a liquid, supplying a material activating the surface of the liquid to the surface of the microstructure, and drying the surface of the microstructure.

2. The method for manufacturing a microstructure according to claim 1, further performing decomposition and removal of the material remaining on the surface of the microstructure.

3. The method for manufacturing a microstructure according to claim 2, wherein the decomposition and removal of the material is based on at least one selected from the group consisting of heating treatment, ozone gas treatment, plasma treatment, and UV (ultraviolet) irradiation treatment.

4. The method for manufacturing a microstructure according to claim 2, wherein the decomposition and removal of the material is performed using superheated steam.

5. The method for manufacturing a microstructure according to claim 1, wherein the supply of the material is performed while the liquid remains on the surface of the microstructure.

6. The method for manufacturing a microstructure according to claim 1, wherein the material is a surfactant.

7. The method for manufacturing a microstructure according to claim 6, wherein the surfactant includes at least one selected from the group consisting of a cationic surfactant, an anionic surfactant, a nonionic surfactant, and a fluorochemical surfactant.

8. The method for manufacturing a microstructure according to claim 6, wherein the surfactant has a double bond in the main chain.

9. The method for manufacturing a microstructure according to claim 6, wherein the surfactant is a low molecular weight surfactant.

10. The method for manufacturing a microstructure according to claim 6, wherein the amount of the surfactant is 0.05 weight % or more and 1 weight % or less.

11. A method for manufacturing a microstructure, comprising: applying hydrophilization treatment to a surface of the microstructure having a wall body, treating the surface with a liquid, and drying the surface.

12. The method for manufacturing a microstructure according to claim 11, wherein the hydrophilization treatment is based on at least one selected from the group consisting of thermal oxidation treatment, oxygen plasma treatment, UV (ultraviolet) irradiation treatment, EB (electron beam) irradiation treatment, normal pressure CVD treatment, reduced pressure CVD treatment, plasma CVD treatment, and surface treatment with a chemical.

13. A system for manufacturing a microstructure, comprising:
a treating device configured to treat a surface of the microstructure having a wall body with a liquid;
an activator supplying device configured to supply a material activating the surface of the liquid to the surface of the microstructure; and
a drying device configured to dry the surface of the microstructure.

14. The system for manufacturing a microstructure according to claim 13, further comprising:
a removing device configured to perform decomposition and removal of the material remaining on the surface of the microstructure.

15. The system for manufacturing a microstructure according to claim 14, wherein the removing device includes a superheater configured to generate superheated steam.

16. The system for manufacturing a microstructure according to claim 13, wherein the material is a surfactant.

17. The system for manufacturing a microstructure according to claim 16, wherein the surfactant includes at least one selected from the group consisting of a cationic surfactant, an anionic surfactant, a nonionic surfactant, and a fluorochemical surfactant.

18. The system for manufacturing a microstructure according to claim 16, wherein the surfactant has a double bond in the main chain.

19. The system for manufacturing a microstructure according to claim 16, wherein the surfactant is a low molecular weight surfactant.

20. The system for manufacturing a microstructure according to claim 16, wherein the amount of the surfactant is 0.05 weight % or more and 1 weight % or less.
